(19) United States
(12) Patent Application Publication
(10) Pub. No.: US 2024/0332486 A1
(43) Pub. Date: Oct. 3, 2024

(54) COATING DEVICE, METHOD, AND ELECTRODE

(71) Applicant: Volkswagen Aktiengesellschaft, Wolfsburg (DE)

(72) Inventors: Ludger BUSSWINKEL, Braunschweig (DE); Sven SCHOPF, Braunschweig (DE); Sebastian REUBER, Dresden (DE); Roland SCHMIDT-LOBACH, Hoersingen (DE)

(73) Assignee: Volkswagen Aktiengesellschaft, Wolfsburg (DE)

(21) Appl. No.: 18/622,368

(22) Filed: Mar. 29, 2024

(30) Foreign Application Priority Data
Mar. 30, 2023 (DE) 10 2023 202 928.6

(51) Int. Cl. H01M 4/04; B05C 1/08

(52) U.S. Cl. CPC H01M 4/0409; H01M 4/0404; B05C 1/083; B05C 1/0834

(57) ABSTRACT

A coating device for producing an electrode with at least one double-layer powder layer on a substrate with a feed unit for feeding a substrate into a first press nip, with a first roller device for transferring a first powder as a first layer onto a first side of the substrate. The first roller device has a first metering unit, a first application roller, a first pressure roller unit, and a second pressure roller unit. A first metering gap is provided between the first application roller and the first pressure roller unit. A first press nip is provided between the first pressure roller unit and the second pressure roller unit. A second roller device transfers a second powder onto the first layer on the first side of the substrate. The second roller device being disposed downstream of the first roller device.

This nonprovisional application claims priority under 35 U.S.C. § 119 (a) to German Patent Application No. 10 2023 202 928.6, which was filed in Germany on Mar. 30, 2023, and which is herein incorporated by reference.

### BACKGROUND OF THE INVENTION

### Field of the Invention

The invention relates to a coating device for producing an electrode with at least one double-layer powder layer on a substrate with the features of independent claim 1, to a method for producing an electrode with at least one double-layer powder layer, in particular a double-layer cathode layer and/or anode layer, on a substrate with the features of independent claim 6, and to an electrode with the features of independent claim 13.

### Description of the Background Art

Electrodes with a single-layer coating have been produced to date in attempts at solvent-free or dry electrode production. In order to improve the performance of battery cells, the approach used in conventional electrode production is to produce electrodes with multilayer coatings (different composition of the individual layers). In this case, these have an increased energy density and electrical conductivity.

Currently, electrodes, produced in a solvent-free manner, with a multilayer coating are often produced as a free-standing film. In this case, two powders are pressed against a current collector in a calender gap.

However, the electrode continues to be processed wet routinely and therefore contains solvents.

A further method is the successive application of individual layers as a free-standing film on the substrate sides designated for this. For example, the individual layers can be applied and pressed on in two successive calender gaps.

Nevertheless, adhesion promoters or a certain moisture of the powder are often required, as otherwise adhesion of the respective layers cannot be guaranteed. This can lead to a substrate or current collector that is not consistently coated. This in turn leads to increased rejects or a lower electrical output of an electrode produced in this way.

### SUMMARY OF THE INVENTION

It is therefore an object of the present invention to at least partially overcome at least one of the above-described disadvantages. In particular, it is the object of the invention to provide a coating device which enables a dry electrode production so that the electrical conductivity or energy density of the electrode is increased. Furthermore, it is the object of the invention to provide a method for dry electrode production and an electrode produced in this way.

The foregoing object is achieved by a coating device with the features of independent claim 1, by a method with the features of independent claim 6, and by an electrode with the features of independent claim 13. Further features and details of the invention emerge from the dependent claims, the description, and the drawings. In this regard, features and details that are described in relation to the coating device of the invention also apply, of course, in relation to the method of the invention and/or in relation to the electrode of the invention, and conversely in each case, so that with regard to the disclosure, reference is or can always be made mutually to the individual aspects of the invention.

According to a first aspect of the invention, a coating device is provided according to the invention for producing an electrode with at least one double-layer powder layer, in particular a double-layer cathode layer and/or anode layer, on a substrate, in particular a current collector, with a feed unit for feeding a substrate into a first press nip with a first roller device for transferring a first powder as a first layer onto a first side of the substrate and with a second roller device for transferring a second powder as a second layer onto the first layer on the first side of the substrate.

Here, the first roller device has a first metering unit for receiving a first powder and for filling a first metering gap with the first powder. In addition, the first roller device has a first application roller, a first pressure roller unit, and a second pressure roller unit, wherein the first metering gap is provided between the first application roller and the first pressure roller unit, and wherein the first press nip is provided between the first pressure roller unit and the second pressure roller unit. The first metering gap is provided here for applying the first powder as a first layer to the first pressure roller unit via a first application force, and the first press nip is provided for transferring the first layer from the first pressure roller unit to a first side of the substrate via a first pressure force.

The second roller device is disposed downstream of the first roller device, wherein the first roller device is designed to feed the substrate, coated on the first side, to a second press nip of the second roller device.

The second roller device has a second metering unit for receiving a second powder and for filling a second metering gap with the second powder. In this regard, the second roller device has a second application roller, a third pressure roller unit, and a fourth pressure roller unit, wherein the second metering gap is provided between the second application roller and the third pressure roller unit, and wherein the second press nip is provided between the third pressure roller unit and the fourth pressure roller unit. Here, the second metering gap is provided for applying the second powder as a second layer to the third pressure roller unit via a second application force, and the second press nip is provided for transferring the second layer from the third pressure roller unit to the first layer of the first side of the fed substrate via a second pressure force.

The coating device is based on a roller-supported coating, in which the first powder is first applied as a first layer to a roller of the first pressure roller unit in order to then be transferred or pressed onto the substrate by a roller or the roller. A further roller-supported coating then takes place, in which the second powder is applied as a second layer to a roller of the third pressure roller unit in order to be then transferred to the first layer by this or another roller. This is particularly advantageous for coating a substrate with a solvent-free and dry powder material, so that the coating device is exceptionally suitable for dry electrode production.

Further, the first application roller of the first roller device and the second application roller of the second roller device can have a lower rotational speed than the pressure roller of the first pressure roller unit and the third pressure roller unit, respectively, which form the metering gap with them. This ensures that the first powder adheres to the first pressure roller unit as the first layer and the second powder adheres to the third pressure roller unit as the second layer. When the powder is applied to the respective application roller, shearing of the powder in the metering gap results. The application forces can therefore be shear forces, so that the application rollers can also be referred to as shear rollers.

The first pressure roller unit and the second pressure roller unit can each have a pressure roller. To apply the pressure force for the transfer of the first layer, the pressure rollers, forming the press nip, of the first and second pressure roller unit rotate against each other at the same rotational speed in order to deliver an optimal coating result. The first application roller can have a lower rotational speed than the pressure roller of the first pressure roller unit, said pressure roller which forms the metering gap with it, thereby ensuring that the first powder and the second powder adhere to the first pressure unit as a first layer in order to be carried by it. The same applies to the third and fourth pressure roller unit of the second roller device. These can also each have a pressure roller, which rotate against each other at the same rotational speed to apply the pressure force for transferring the second layer to the first layer.

In this regard, the rotational speeds of the first and second pressure roller unit are adapted to the rotational speed of the third and fourth pressure roller unit so that the shear forces on the already applied first layer in the second press nip are as low as possible in order not to destroy the coating.

The successive application of the individual layers of the double-layer powder layer results in a reduced boundary layer between the first powder and the second powder, therefore, the first layer and the second layer of the first double-layer powder layer, because no mixing of the first and second powders results.

In the context of the invention, it may be advantageous for the first roller device to have a third metering unit for receiving a third powder and for filling a third metering gap with the third powder, and for the first roller device to have a third application roller, wherein the third metering gap is provided between the third application roller and the second pressure roller unit, wherein the third metering gap is provided for applying the third powder as a third layer to the third pressure roller unit via a third application force. The first press nip is provided for transferring the third layer from the second pressure roller unit to a second side of the substrate via the first pressure force.

This enables a parallel application of the first layer on the first side of the substrate and the third layer on the second side of the substrate via the first pressure force in the first press nip.

The second roller device can have a fourth metering unit for receiving a fourth powder and for filling a fourth metering gap with the fourth powder and that the second roller device has a fourth application roller, wherein the fourth metering gap is provided between the fourth application roller and the fourth pressure roller unit, wherein the fourth metering gap is provided for applying the fourth powder as a fourth layer to the fourth pressure roller unit via a fourth application force, and wherein the second press nip is provided for transferring the fourth layer from the fourth pressure roller unit to the third layer of the second side of the substrate via the second pressure force.

This enables a parallel application of the second layer to the first layer of the substrate and the fourth layer to the third layer of the substrate via the second pressure force in the second press nip.

In this regard, the properties and features of the coating device mentioned in connection with the first and second application rollers apply analogously to the properties and features in connection with the third and fourth application rollers.

Further, the third application roller of the first roller device and the fourth application roller of the second roller device can have a lower rotational speed than the pressure roller of the second pressure roller unit and the fourth pressure roller unit, respectively, which form the metering gap with them. This ensures that the third powder adheres to the second pressure roller unit as the third layer and the fourth powder adheres to the fourth pressure roller unit as the fourth layer.

In the context of the invention, it can be provided that the first pressure roller unit of the first roller device has at least one first pressure roller and at least one second pressure roller, wherein at least one first compression gap is provided between the at least one first pressure roller and the at least one second pressure roller. Additionally or alternatively, the second pressure roller unit of the first roller device has at least one third pressure roller and at least one fourth pressure roller, wherein at least one second compression gap is provided between the at least one third pressure roller and the at least one fourth pressure roller. Additionally or alternatively, the third pressure roller unit of the second roller device has at least one fifth pressure roller and at least one sixth pressure roller, wherein at least one third compression gap is provided between the at least one fifth pressure roller and the at least one sixth pressure roller. Additionally or alternatively, the fourth pressure roller unit of the second roller device has at least one seventh pressure roller and at least one eighth pressure roller, wherein at least one fourth compression gap is provided between the at least one seventh pressure roller and the at least one eighth pressure roller.

The first compression gap and/or the second compression gap and/or the third compression gap and/or the fourth compression gap compress the first layer or the second layer or the third layer or the fourth layer, respectively, before it is transferred to the substrate. A denser packing of the first double-layer powder layer can be produced thereby, wherein the first double-layer powder layer has the first layer and the second layer. At the same time, a denser packing of the second double-layer powder layer can also be produced, wherein the second double-layer powder layer has the third layer and the fourth layer. This in turn can further improve the electrical conductivity. Further, a compression gap has the additional effect that lower forces have to act for application or transfer both in the metering gap and in the press nip, so that the shear forces acting in the gaps can be reduced. This produces an even application and transfer and reduces the failure points during application and transfer.

In the area of the first metering gap, a first shielding plate can be provided in the area of the first application roller and/or that a second shielding plate can be provided in the area of the first pressure roller unit. In the area of the second metering gap, a third shielding plate can be provided in the area of the second application roller and/or that a fourth shielding plate can be provided in the area of the third pressure roller unit. In the area of the third metering gap, a fifth shielding plate can be provided in the area of the third application roller and/or that a sixth shielding plate is provided in the area of the second pressure roller unit. In the area of the fourth metering gap, a seventh shielding plate can be provided in the area of the fourth application roller and/or that an eighth shielding plate can be provided in the area of the fourth pressure roller unit.

The shielding plates ensure that the powder does not apply itself to the respective pressure roller unit before the metering gap or adheres to the application roller assigned to the respective pressure roller unit. At the same time, the powder feed into the first metering gap and/or second metering gap can be easily controlled using such shielding plates. At the same time, the shielding plates can have a structure in order to clean the respective application roller and/or the respective pressure roller unit or to remove adhering materials. This enables the cleanest possible application of a new first and/or second and/or third and/or fourth layer or a clean transfer of the first and/or second layer to the substrate or the third layer to the first layer and/or the fourth layer to the second layer.

Furthermore, in the coating device, the first application roller and/or the second application roller and/or the third application roller and/or the fourth application roller and/or the first pressure roller unit and/or the second pressure roller unit and/or the third pressure roller unit and/or the fourth pressure roller unit can be temperature-controlled.

This can considerably simplify the application and transfer of the various powders or layers to the rollers or the substrate, because the adhesion to the surfaces can be adapted to the materials to be applied.

The above object is further achieved according to a second aspect of the invention by a method of the invention for producing an electrode with at least one double-layer powder layer, in particular a double-layer cathode layer and/or anode layer, on a substrate, in particular a current collector, in a coating device according to one of the preceding claims, can include the following steps: feeding a substrate into the first press nip of the first roller device via the feed unit; filling the first metering gap with the first powder via the first metering unit; applying the first powder as a first layer to the first pressure roller unit in the first metering gap via the first application force; transferring the first layer to the first side of the substrate in the first press nip via the first pressure force; feeding the substrate with the transferred first layer into the second press nip of the second roller device; filling the second metering gap with the second powder via the second metering unit; applying the second powder as a second layer to the third pressure roller unit in the second metering gap via the second application force; and transferring the second layer to the first layer of the first side of the substrate in the second press nip via the second pressure force.

The successive application of the first layer and the second layer has the result that the first layer is additionally compressed; this has a beneficial effect on the electrical conductivity and energy density of the electrode that can be produced therewith.

The third metering unit can fill the third metering gap with the third powder, wherein the third powder is applied as a third layer to the second pressure roller unit in the third metering gap via the third application force, and that the third layer is transferred to the second side of the substrate in the first press nip via the first pressure force.

Via the third metering unit and the third application roller, it is possible to transfer the third layer to the second side of the substrate at the same time as transferring the first layer to the first side of the substrate. This saves time and is efficient.

In the context of the invention, it is optionally possible that the fourth metering unit fills the fourth metering gap with the fourth powder, wherein the fourth powder is applied as a fourth layer to the fourth pressure roller unit in the fourth metering gap via the fourth application force, and that the fourth layer is transferred to the third layer of the second side of the substrate in the second press nip via the second pressure force.

Via the fourth metering unit and the fourth application roller, it is possible to transfer the fourth layer to the third layer of the second side of the substrate at the same time as transferring the second layer to the first layer of the first side of the substrate. This saves time and is efficient.

Further, in the context of the invention, it can be provided that the first metering unit continuously fills the first metering gap and/or that the second metering unit continuously fills the second metering gap and/or that the third metering unit continuously fills the third metering gap and/or that the fourth metering unit continuously fills the fourth metering gap.

This leads to a particularly uniform result when producing the respective layers on the pressure roller units and for transferring from the pressure roller units to the substrate or to the layers already applied to the substrate.

With reference to the present invention, the first layer can be compressed in the at least one first compression gap of the first pressure roller unit of the first roller device. The third layer can be compressed in the at least one second compression gap of the second pressure roller unit of the first roller device. The second layer can be compressed in the at least one third compression gap of the third pressure roller unit of the second roller device. The fourth layer can be compressed in the at least one fourth compression gap of the fourth pressure roller unit of the second roller device.

The compression in the respective compression gap leads to a compaction of the first layer and/or second layer and/or third layer and/or fourth layer in order to produce a denser packing of the respective at least double-layer powder layer on the first and/or second side of the substrate. This makes possible a reduction of the first application force and/or the second application force and/or the third application force and/or the fourth application force and/or the first pressure force and/or the second pressure force.

Further, the first application roller and/or the second application roller and/or the third application roller and/or the fourth application roller and/or the first pressure roller unit and/or the second pressure roller unit and/or the third pressure roller unit and/or the fourth pressure roller unit can be controlled to a temperature between 80° C. and 150° C., in particular 100°° C. and 120° C.

This enables an improved application of the first and second powder as the first layer onto the first pressure roller unit and/or the third and fourth powders as the second layer onto the second pressure roller unit. Furthermore, the temperature control of the individual rollers can improve the transfer of the first layer to the first side of the substrate and/or the third layer to the second side of the substrate and/or the second layer to the first layer of the first side of the substrate and/or the fourth layer to the third layer on the second side of the substrate, because the individual bonds of the individual powders of the respective layers are increased by the heat.

The feed unit can be temperature-controlled in order to preheat the substrate for the transfer, therefore, the pressing, of the first layer onto the first side of the substrate and/or of the third layer onto the second side of the substrate.

In the context of the invention, it may be advantageous for the first pressure roller unit and the second pressure roller unit of the first roller device to rotate against each other at the same first rotational speed, wherein the ratio of the first rotational speed of the first pressure roller unit to the second rotational speed of the first application roller is 10:1 to 10:4, preferably 10:1.5 to 10:3, more preferably 10:2 to 10:3, and/or the ratio of the first rotational speed of the second pressure roller unit to the fifth rotational speed of the third application roller is 10:1 to 10:4, preferably 10:1.5 to 10:3, more preferably 10:2 to 10:3. The third pressure roller unit and the fourth pressure roller unit of the second roller device can rotate against each other at the same third rotational speed, wherein the ratio of the third rotational speed of the third pressure roller unit to the fourth rotational speed of the second application roller is 10:1 to 10:4, preferably 10:1.5 to 10:3, more preferably 10:2 to 10:3, and/or the ratio of the third rotational speed of the fourth pressure roller unit to the sixth rotational speed of the fourth application roller is 10:1 to 10:4, preferably 10:1.5 to 10:3, more preferably 10:2 to 10:3.

If the first pressure roller unit of the first roller device has the first and second pressure rollers and/or the second pressure roller unit of the first roller device has the third and fourth pressure rollers, then the first rotational speed is regarded as the rotational speed of the first pressure roller of the first pressure roller unit and of the third pressure roller of the second pressure roller unit, because these form the first press nip. The second pressure roller and the fourth pressure roller can each have a rotational speed that differs from the first rotational speed. For example, the ratio of the first rotational speed of the first and third pressure roller to the rotational speed of the second and/or fourth pressure roller can be 10:5 to 10:8, preferably 10:6 to 10:8, more preferably 10:7 to 10:8.

If the third pressure roller unit of the second roller device has the fifth and sixth pressure roller and/or the fourth pressure roller unit of the second roller device has the seventh and eighth pressure roller unit, then the third rotational speed is regarded as the rotational speed of the fifth and seventh pressure roller, because these form the second press nip. Here as well, the sixth and eighth pressure rollers can each have a rotational speed that differs from the third rotational speed. For example, the ratio of the third rotational speed of the fifth and seventh pressure roller to the rotational speed of the sixth and/or eighth pressure roller can be 10:5 to 10:8, preferably 10:6 to 10:8, more preferably 10:7 to 10:8.

Advantageously, it has been found that the ratios of the rotational speeds lead to an increased stability of the first layer or the first at least double-layer powder layer on the current collector of the electrode and/or the second layer or the second at least double-layer powder layer on the current collector of the electrode.

The above object is further achieved according to a third aspect of the invention by an electrode of the invention with a double-layer powder layer produced with a coating device described above and/or with a method described above, wherein the substrate is a current collector with a first side and a second side, wherein the first layer of the double-layer powder layer is made of the first powder and the second layer of the double-layer powder layer is made of the second powder.

The third layer of the double-layer powder layer can be made of the third powder and the fourth layer of the double-layer powder layer is made of the fourth powder.

The electrode can be used as an anode, but also as a cathode. It is conceivable here that the double-layer powder layer of the cathode can differ from the double-layer powder layer of the anode. It is also conceivable that the current collector of the anode can differ from the current collector of the cathode.

Such an electrode has an optimally compacted double-layer powder layer, wherein the double-layer powder layer is solvent-free. At the same time, an electrode produced in this way has a high electrical conductivity and energy density.

A particularly good ratio of the use of materials for the first, second, third, and fourth powders for the double-layer powder layer to the existing electrical conductivity is achieved if the double-layer powder layer has a layer thickness between 40 and 150 μm, wherein the first powder of the first layer and the third powder of the third layer have a layer thickness of 10 to 70 μm. Consequently, the use of materials can also be made cost-effective.

Advantages which have been described in detail for the coating device according to the first aspect of the invention also apply equally to the method according to the second aspect of the invention and to an electrode according to the third aspect of the invention.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic representation of a coating device for applying and transferring a first double-layer powder layer;

FIG. 2 is a schematic representation of a coating device for applying and transferring a first and a second double-layer powder layer;

FIG. 3 shows a detail of a first metering gap from FIG. 1;

FIG. 4 is a schematic representation of a method with a coating device according to FIG. 1;

FIG. 5 is a schematic representation of a method with a coating device according to FIG. 2; and

FIG. 6 is a schematic representation of an electrode.

### DETAILED DESCRIPTION

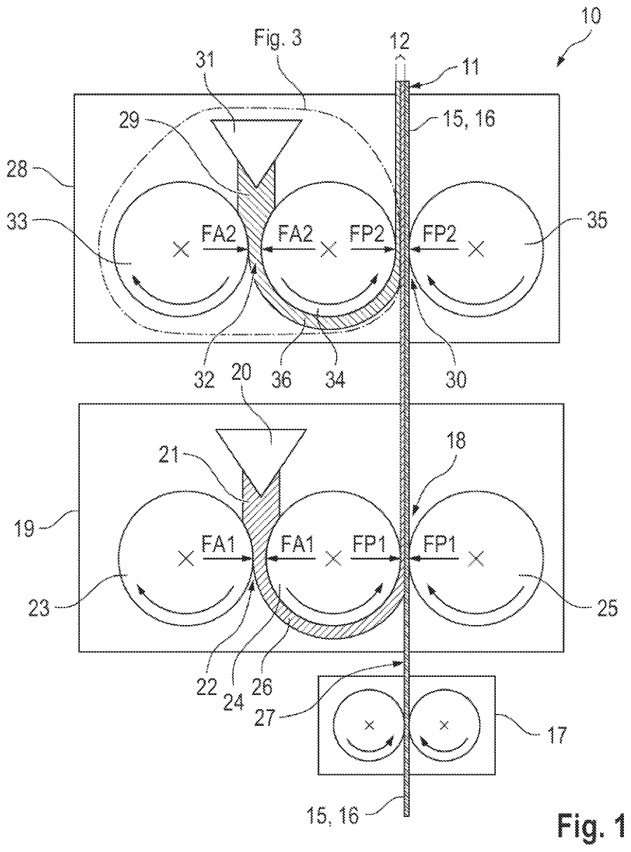

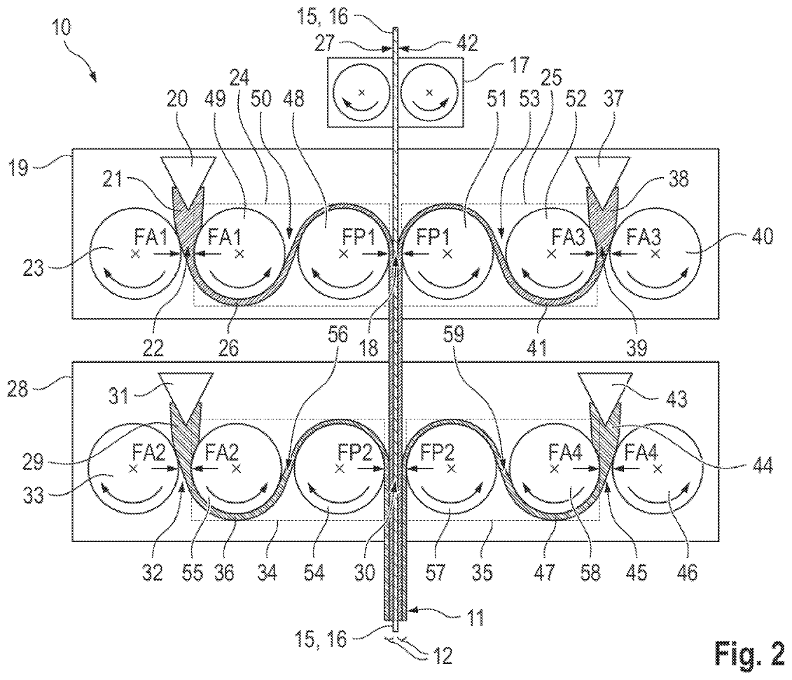

FIG. 1 and FIG. 2 each show a coating device 10 for producing an electrode 11 with at least one double-layer powder layer 12, in particular a double-layer cathode layer 13 and/or anode layer 14, on a substrate 15, in particular a current collector 16. In this regard, FIG. 1 shows a coating device 10 for the one-sided coating of a substrate 15 by applying 130 and transferring 140 the at least one first double-layer powder layer 12 and FIG. 2 shows a coating device 10 for the double-sided coating of a substrate 15 by applying 130, 180 and transferring 140, 190 the at least one first double-layer powder layer 12—first and second layer 26, 36—and the at least one second double-layer powder layer 12—third and fourth layer 41, 47.

Coating device 10 of both FIG. 1 and FIG. 2 has a feed unit 17 for feeding 110 a substrate 15 into a first press nip 18, a first roller device 19 for transferring 140 a first powder 21 as a first layer 26 to a first side 27 of substrate 15, and a second roller device 28 for transferring 140 a second powder 29 to first layer 26 on first side 27 of substrate 15.

Here, first roller device 19 has a first metering unit 20 for receiving a first powder 21 and for filling a first metering gap 22 with first powder 21. Further, first roller device 19 provides a first application roller 23, a first pressure roller unit 24, and a second pressure roller unit 25. In this case, first metering gap 22 is provided between first application roller 23 and first pressure roller unit 24, and first press nip 18 is provided between first pressure roller unit 24 and second pressure roller unit 25.

Here, first metering gap 22 is used to apply 130 first powder 21 as a first layer 26 to first pressure roller unit 24 via a first application force FA1 and first press nip 18 is used to transfer 140 first layer 26 from first pressure roller unit 24 to a first side 27 of substrate 15 via a first pressure force FP1.

Second roller device 28 is disposed downstream of first roller device 19. In this case, first roller device 19 is designed to feed substrate 15, coated on first side 27, to a second press nip 30 of second roller device 28.

Second roller device 28 has a second metering unit 31 for receiving a second powder 29 and for filling a second metering gap 32 with second powder 29. Further, second roller device 28 has a second application roller 33, a third pressure roller unit 34, and a fourth pressure roller unit 35. In this case, second metering gap 32 is provided between second application roller 33 and third pressure roller unit 34. Second press nip 30 is in turn provided between third pressure roller unit 34 and fourth pressure roller unit 35. Here, second metering gap 32 is provided for applying 130 second powder 29 as a second layer 36 to third pressure roller unit 34 via a second application force FA2 and second press nip 30 is provided for transferring 140 second layer 36 from third pressure roller unit 34 to first layer 26 of first side 27 of fed substrate 15 via a second pressure force FP2.

In order to be able to apply a double-layer powder layer 12 on both sides to a substrate 15, first roller device 19 of coating device 10 in FIG. 2 has a third metering unit 37 for receiving a third powder 38 and for filling a third metering gap 39 with third powder 38. Further, a third application roller 40 is provided, wherein third metering gap 39 is provided between third application roller 40 and second pressure roller unit 25. Third metering gap 39 is used to apply 130 third powder 38 as third layer 41 to third pressure roller unit 34 via a third application force FA3. In this constellation as well, first press nip 18 is provided for transferring 140 third layer 41 from second pressure roller unit 25 to a second side 42 of substrate 15 via first pressure force FP1.

In addition, second roller device 28 has a fourth metering unit 43 for receiving a fourth powder 44 and for filling a fourth metering gap 45 with fourth powder 44. A fourth application roller 46 is provided for this purpose, wherein fourth metering gap 45 is provided between fourth application roller 46 and fourth pressure roller unit 35. Fourth metering gap 45 is provided for applying 130 fourth powder 44 as a fourth layer 47 to fourth pressure roller unit 35 via a fourth application force FA4. Second press nip 30 is provided for transferring 140 fourth layer 47 from fourth pressure roller unit 35 to third layer 41 of second side 42 of substrate 15 via second pressure force FP2.

Furthermore, it is shown in regard to coating device 10 according to FIG. 2 that first pressure roller unit 24 of first roller device 19 has at least one first pressure roller 48 and at least one second pressure roller 49, wherein at least one first compression gap 50 is provided between the at least one first pressure roller 48 and the at least one second pressure roller 49, and that second pressure roller unit 25 of first roller device 19 has at least one third pressure roller 51 and at least one fourth pressure roller 52, wherein at least one second compression gap 53 is provided between the at least one third pressure roller 51 and the at least one fourth pressure roller 52. In addition, third pressure roller unit 34 of second roller device 28 has at least one fifth pressure roller 54 and at least one sixth pressure roller 55, wherein at least one third compression gap 56 is provided between the at least one fifth pressure roller 54 and the at least one sixth pressure roller 55. Further, in addition, fourth pressure roller unit 35 of second roller device 28 has at least one seventh pressure roller 57 and at least one eighth pressure roller 58, wherein at least one fourth compression gap 59 is provided between the at least one seventh pressure roller 57 and the at least one eighth pressure roller 58.

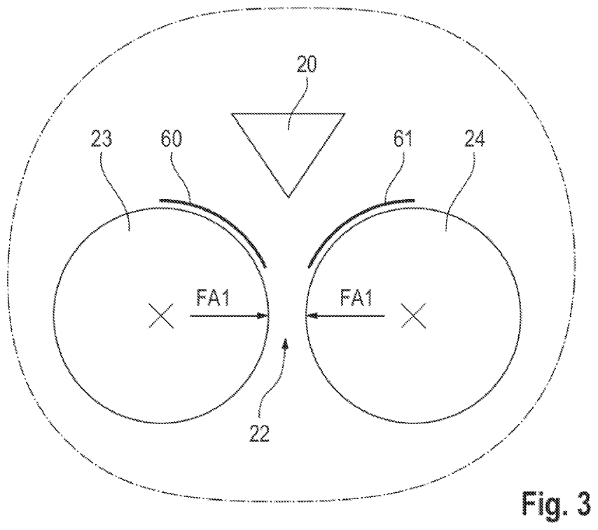

An enlarged detail of a first metering gap 22 with a first metering unit 20 is shown in FIG. 3, as it can be designed both in coating device 10 according to FIG. 1 as well as FIG. 2. In this case, in the area of first metering gap 22, a first shielding plate 60 is provided in the area of first application roller 23 and/or a second shielding plate 61 is provided in the area of first pressure roller unit 24.

In the area of second metering gap 32, a third shielding plate 62 can be provided in the area of second application roller 33 and/or that a fourth shielding plate 63 is provided in the area of third pressure roller unit 34 and/or that in the area of third metering gap 39, a fifth shielding plate 64 is provided in the area of third application roller 40 and/or a sixth shielding plate 65 is provided in the area of second pressure roller unit 25 and/or that in the area of fourth metering gap 45, a seventh shielding plate 66 is provided in the area of fourth application roller 46 and/or that an eighth shielding plate 67 is provided in the area of fourth pressure roller unit 35.

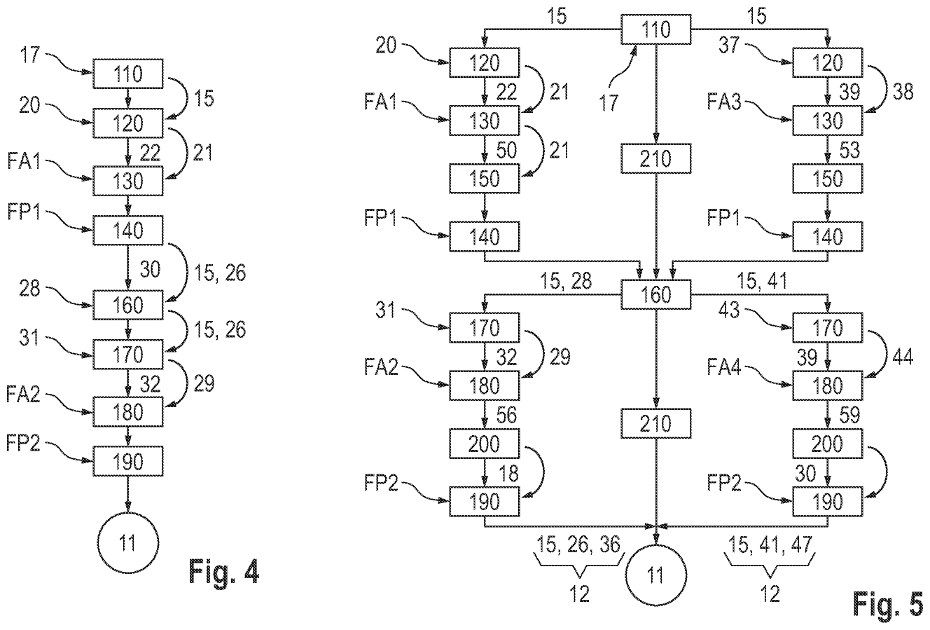

FIGS. 4 and 5 each show a method 100 for producing an electrode 11 with at least one double-layer powder layer 12, in particular a double-layer cathode layer 13 and/or anode layer 14, on a substrate 15, in particular a current collector 16, in a coating device 10 according to one of FIG. 1 or 2. The methods can include the following steps: feeding 110 a substrate 15 into first press nip 18 of first roller device 19 via feed unit 17; filling 120 first metering gap 22 with first powder 21 via first metering unit 20; applying 130 first powder 21 as a first layer 26 to first pressure roller unit 24 in first metering gap 22 via first application force FA1; transferring 140 first layer 26 to first side 27 of substrate 15 in first press nip 18 via first pressure force FP1; feeding 160 substrate 15 with the transferred 140 first layer 26 into second press nip 30 of second roller device 28; and/or filling 170 second metering gap 32 with second powder 29 via second metering unit 31; applying 180 second powder 29 as a second layer 36 to third pressure roller unit 34 in second metering gap 32 via second application force FA2; transferring 190 second layer 36 to first layer 26 of first side 27 of substrate 15 in second press nip 30 via second pressure force FP2.

Coating device 10 according to FIG. 2 has third metering unit 37, so that in the method according to FIG. 5 third metering unit 37 fills 120 third metering gap 39 with third powder 38, wherein third powder 38 is applied 130 as third layer 41 to second pressure roller unit 25 in third metering gap 39 via third application force FA3, and that third layer 41 is transferred 140 to second side 42 of substrate 15 in first press nip 18 via first pressure force FP1.

Further, a fourth metering unit 43 is also provided in coating device 10 according to FIG. 2, so that in the method according to FIG. 5, fourth metering unit 43 fills 170 fourth metering gap 45 with fourth powder 44, wherein fourth powder 44 is applied 180 as fourth layer 47 to fourth pressure roller unit 35 in fourth metering gap 45 via fourth application force FA4, and that fourth layer 47 is transferred 140 to third layer 41 of second side 42 of substrate 15 in second press nip 30 via second pressure force FP2.

For a good result of the coating application to substrate 15, coating device 10 and method 100 are designed such that first metering unit 20 continuously fills 120 first metering gap 22 and that second metering unit 31 continuously fills 170 second metering gap 32 and that third metering unit 37 continuously fills 120 third metering gap 39 and that fourth metering unit 43 continuously fills 170 fourth metering gap 45.

In method 100 according to FIG. 5, first layer 26 is compressed 150 in the at least one first compression gap 50 of first pressure roller unit 24 of first roller device 19 and third layer 41 is compressed 150 in the at least one second compression gap 53 of second pressure roller unit 25 of first roller device 19. In addition, second layer 36 is compressed 200 in the at least one third compression gap 56 of third pressure roller unit 34 of second roller device 28 and fourth layer 47 is compressed 200 in the at least one fourth compression gap 59 of fourth pressure roller unit 35 of second roller device 28.

For a better application 130 of the layers and transfer 140 of the layers, first application roller 23 and second application roller 33, as they are shown in FIGS. 1 and 2, and third application roller 40 and fourth application roller 46, as shown in FIG. 2, as well as first pressure roller unit 24 and second pressure roller unit 25 and third pressure roller unit 34 and fourth pressure roller unit 35 of FIGS. 1 and 2, as shown in FIGS. 4 and 5, are controlled 210 to a temperature between 80° C. and 150° C.

In the embodiment of method 100 according to FIG. 4 with coating device 10 according to FIG. 1 or in method 100 according to FIG. 5 with coating device 10 according to FIG. 2, first pressure roller unit 24 and second pressure roller unit 25 of first roller device 19 rotate against each other at the same first rotational speed v1, wherein the ratio of the first rotational speed v1 of first pressure roller unit 24 to the second rotational speed v2 of first application roller 23 is 10:1 to 10:4. At the same time, third pressure roller unit 34 and fourth pressure roller unit 35 of second roller device 28 rotate against each other at the same third rotational speed v3, wherein the ratio of the third rotational speed v3 of third pressure roller unit 34 to the fourth rotational speed v4 of second application roller 33 is 10:1 to 10:4.

In the method 100 according to FIG. 5, the ratio of the first rotational speed v1 of second pressure roller unit 25 to the fifth rotational speed v5 of third application roller 40 is 10:1 to 10:4 and the ratio of the third rotational speed v3 of fourth pressure roller unit 35 to the sixth rotational speed v6 of fourth application roller 46 is 10:1 to 10:4.

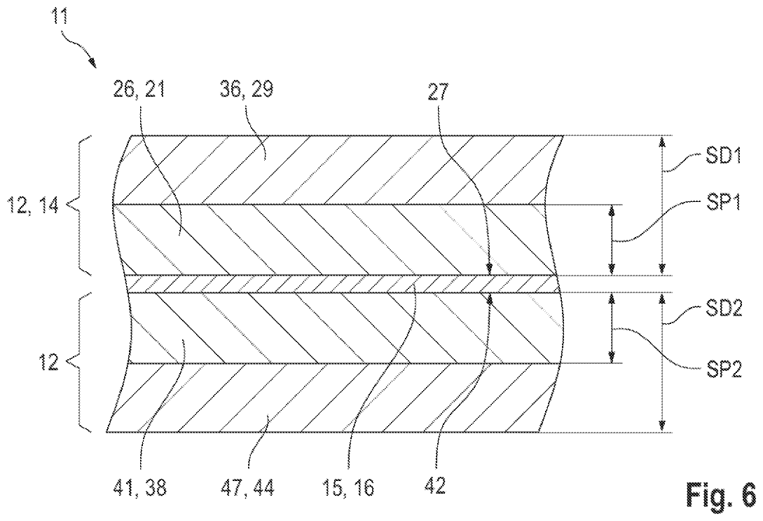

FIG. 6 shows an electrode 11 with a double-layer powder layer 12 produced with a coating device 10 according to either FIG. 1 or FIG. 2 and/or with a method 100 according to one of the methods shown in FIG. 3 or FIG. 4. In this case, substrate 15 is a current collector 16 with a first side 27 and a second side 42, wherein first layer 26 of double-layer powder layer 12 is made of first powder 21 and second layer 36 of double-layer powder layer 12 is made of second powder 29.

In addition, third layer 41 of double-layer powder layer 12 is made of third powder 38 and fourth layer 47 of double-layer powder layer 12 is made of fourth powder 44.

In this case, double-layer powder layer 12 on first side 27 of substrate 15 has a first layer thickness SD1 and respectively double-layer powder layer 12 on second side 42 of substrate 15 has a second layer thickness SD2 of between 40 and 150 μm, wherein first powder 21 of first layer 26 has a first layer thickness SP1 of 10 to 70 μm and third powder 38 of third layer 41 has a second layer thickness SP2 of 10 to 70 μm. Consequently, the use of materials can also be made cost-effective.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A coating device for producing an electrode with at least one double-layer powder layer, in particular a double-layer cathode layer and/or anode layer on a substrate or a current collector, the coating device comprising:
a feed unit to feed a substrate into a first press nip;
a first roller device to transfer a first powder as a first layer onto a first side of the substrate, the first roller device having a first metering unit for receiving a first powder and for filling a first metering gap with a first powder; and
a second roller device for transferring a second powder onto the first layer on the first side of the substrate,
wherein the first roller device has a first application roller, a first pressure roller unit, and a second pressure roller unit,
wherein the first metering gap is provided between the first application roller and the first pressure roller unit,
wherein the first press nip is provided between the first pressure roller unit and the second pressure roller unit,
wherein the first metering gap is provided for applying the first powder as a first layer to the first pressure roller unit via a first application force,
wherein the first press nip is provided for transferring the first layer from the first pressure roller unit to a first side of the substrate via a first pressure force,
wherein the second roller device is disposed downstream of the first roller device,
wherein the first roller device is designed to feed the substrate coated on the first side, to a second press nip of the second roller device,
wherein the second roller device has a second metering unit for receiving a second powder and for filling a second metering gap with the second powder,
wherein the second roller device has a second application roller, a third pressure roller unit, and a fourth pressure roller unit,
wherein the second metering gap is provided between the second application roller and the third pressure roller unit,
wherein the second press nip is provided between the third pressure roller unit and the fourth pressure roller unit,
wherein the second metering gap is provided for applying the second powder as a second layer to the third pressure roller unit via a second application force, and
wherein the second press nip is provided for transferring the second layer from the third pressure roller unit to the first layer of the first side of the fed substrate via a second pressure force.

2. The coating device according to claim 1, wherein the first roller device has a third metering unit for receiving a third powder and for filling a third metering gap with the third powder, wherein the first roller device has a third application roller, wherein the third metering gap is provided between the third application roller and the second pressure roller unit, wherein the third metering gap is provided for applying the third powder as the third layer to the third pressure roller unit via a third application force, and wherein the first press nip is provided for transferring the third layer from the second pressure roller unit to a second side of the substrate via the first pressure force.

3. The coating device according to claim 1, wherein the second roller device has a fourth metering unit for receiving a fourth powder and for filling a fourth metering gap with the fourth powder, wherein the second roller device has a fourth application roller, wherein the fourth metering gap is provided between the fourth application roller and the fourth pressure roller unit, wherein the fourth metering gap is provided for applying the fourth powder as a fourth layer to the fourth pressure roller unit via a fourth application force, and wherein the second press nip is provided for transferring the fourth layer from the fourth pressure roller unit to the third layer of the second side of the substrate via the second pressure force.

4. The coating device according to claim 1, wherein the first pressure roller unit of the first roller device has at least one first pressure roller and at least one second pressure roller, wherein at least one first compression gap is provided between the at least one first pressure roller and the at least one second pressure roller, and/or wherein the second pressure roller unit of the first roller device has at least one third pressure roller and at least one fourth pressure roller, wherein at least one second compression gap is provided between the at least one third pressure roller and the at least one fourth pressure roller, and/or wherein the third pressure roller unit of the second roller device has at least one fifth pressure roller and at least one sixth pressure roller, wherein at least one third compression gap is provided between the at least one fifth pressure roller and the at least one sixth pressure roller, and/or wherein the fourth pressure roller unit of the second roller device has at least one seventh pressure roller and at least one eighth pressure roller, wherein at least one fourth compression gap is provided between the at least one seventh pressure roller and the at least one eighth pressure roller.

5. The coating device according to claim 1, wherein in an area of the first metering gap, a first shielding plate is provided in an area of the first application roller and/or a second shielding plate is provided in an area of the first pressure roller unit, and/or wherein in the area of the second metering gap, a third shielding plate is provided in an area of the second application roller and/or a fourth shielding plate is provided in an area of the third pressure roller unit, and/or wherein in an area of the third metering gap, a fifth shielding plate is provided in an area of the third application roller and/or a sixth shielding plate is provided in an area of the second pressure roller unit and/or wherein in an area of the fourth metering gap, a seventh shielding plate is provided in an area of the fourth application roller and/or wherein an eighth shielding plate is provided in an area of the fourth pressure roller unit.

6. A method for producing an electrode with at least one double-layer powder layer, in particular a double-layer cathode layer and/or anode layer on a substrate, in particular a current collector, in a coating device according to claim 1, the method comprising:
feeding a substrate into the first press nip of the first roller device via the feed unit;
filling the first metering gap with the first powder via the first metering unit;
applying the first powder as a first layer to the first pressure roller unit in the first metering gap via the first application force;
transferring the first layer to the first side of the substrate in the first press nip via the first pressure force;
feeding the substrate with the transferred first layer into the second press nip of the second roller device;
filling the second metering gap with the second powder via the second metering unit;
applying the second powder as a second layer to the third pressure roller unit in the second metering gap via the second application force; and
transferring the second layer to the first layer of the first side of the substrate in the second press nip via the second pressure force.

7. The method according to claim 6, wherein the third metering unit fills the third metering gap with the third powder, wherein the third powder is applied as the third layer to the second pressure roller unit in the third metering gap via the third application force, and wherein the third layer is transferred to the second side of the substrate in the first press nip via the first pressure force.

8. The method according to claim 6, wherein the fourth metering unit fills the fourth metering gap with the fourth powder, wherein the fourth powder is applied as the fourth layer to the fourth pressure roller unit in the fourth metering gap via the fourth application force, and wherein the fourth layer is transferred to the third layer of the second side of the substrate in the second press nip via the second pressure force.

9. The method according to claim 6, wherein the first metering unit continuously fills the first metering gap and/or wherein the second metering unit continuously fills the second metering gap, and wherein the third metering unit continuously fills the third metering gap, and wherein the fourth metering unit continuously fills the fourth metering gap.

10. The method according to claim 6, wherein the first layer is compressed in the at least one first compression gap of the first pressure roller unit of the first roller device and/or wherein the third layer is compressed in the at least one second compression gap of the second pressure roller unit of the first roller device and/or wherein the second layer is compressed in the at least one third compression gap of the third pressure roller unit of the second roller device and/or wherein the fourth layer is compressed in the at least one fourth compression gap of the fourth pressure roller unit of the second roller device.

11. The method according to claim 6, wherein the first application roller and/or the second application roller and/or the third application roller and/or the fourth application roller and/or the first pressure roller unit and/or the second pressure roller unit and/or the third pressure roller unit and/or the fourth pressure roller unit are controlled to a temperature between 80° C. to 150° C.

12. The method according to claim 6, wherein the first pressure roller unit and the second pressure roller unit of the first roller device rotate against each other at the same first rotational speed, wherein the ratio of the first rotational speed of the first pressure roller unit to the second rotational speed of the first application roller is 10:1 to 10:4 or 10:1.5 to 10:3 or 10:2 to 10:3, and/or wherein the ratio of the first rotational speed of the second pressure roller unit to the fifth rotational speed of the third application roller is 10:1 to 10:4 or 10:1.5 to 10:3 or 10:2 to 10:3, and/or wherein the third pressure roller unit and the fourth pressure roller unit of the second roller device rotate against each other at the same third rotational speed, wherein a ratio of the third rotational speed of the third pressure roller unit to the fourth rotational speed of the second application roller is 10:1 to 10:4 or 10:1.5 to 10:3 or 10:2 to 10:3, and/or wherein a ratio of the third rotational speed of the fourth pressure roller unit to the sixth rotational speed of the fourth application roller is 10:1 to 10:4 or 10:1.5 to 10:3 or 10:2 to 10:3.

13. An electrode with a double-layer powder layer produced with the coating device according to claim 1, wherein the substrate is a current collector with a first side and a second side, wherein the first layer of the double-layer powder layer is made of the first powder and the second layer of the double-layer powder layer is made of the second powder.

14. The electrode according to claim 13, wherein the third layer of the double-layer powder layer is made of the third powder and the fourth layer of the double-layer powder layer is made of the fourth powder.
